(19) United States
(12) Patent Application Publication
(10) Pub. No.: US 2023/0011295 A1
(43) Pub. Date: Jan. 12, 2023

(54) Additive Manufacturing Acoustic Infill Metamaterial with Perforated Nozzles for Acoustic Noise Reduction

(71) Applicant: United States of America as Represented by the Secretary of the Army, Washingon, DC (US)

(72) Inventors: Brittany Consuegra Griffin, Huntsville, AL (US); Thomas J. DuPuy, V, Madison, AL (US); Ronald S. Legowik, Winchester, TN (US); Gregory T. Jones, Meridianville, AL (US)

(73) Assignee: United States of America as Represented by the Secretary of the Army, Washingon, DC (US)

(21) Appl. No.: 17/860,009

(22) Filed: Jul. 7, 2022

Related U.S. Application Data
(60) Provisional application No. 63/220,348, filed on Jul. 9, 2021.
(60) Provisional application No. 63/220,541, filed on Jul. 11, 2021.

(51) Int. Cl. G10K 11/162

(52) U.S. Cl. CPC G10K 11/162

(57) ABSTRACT

An acoustic metamaterial structure acts as a sound reducing filter in that the level of sound that exits the structure is much less than the magnitude of sound that enters the structure. In forming the structure, modular stages of a given geometry are stacked upon one another to create a cell. Each stage of the cell is provided with a nozzle that is acoustically connected to the nozzles of other stages of the cell. The stages have chambers that are positioned radially or laterally outside of the respective nozzles, with the chambers of the cell being acoustically connected to one another. An amalgamation of cells are arranged in an adjacent formation, with chambers of the cells being acoustically connected to one another for purposes of protecting items, components and people from destructive levels of sound. The geometry of the nozzles and chambers are designed for economical additive manufacture with acoustic infills.

Priority is claimed to Provisional Application No. 63/220,541 filed on Jul. 11, 2021 and to provisional application No. 63/220,348 filed on Jul. 9, 2021 which are hereby incorporated by reference.

### GOVERNMENT RIGHTS

All rights in the invention have been assigned to the U.S. Government.

### RELATED APPLICATION

The co-pending non-provisional application for “Metamaterial Design with Perforated Nozzles for Acoustic Noise Reduction”, application no., filed, is hereby incorporated by reference.

### BACKGROUND OF THE INVENTION

### 1. Field of Invention

The present invention pertains to acoustic metamaterial structures. More particularly, the present invention pertains to an acoustic metamaterial structure having a nozzle having axial and radially oriented passageways extending into various chambers. Stages of such acoustic metamaterial structures are stacked upon one another to form cells such that sound waves are diminished in amplitude as they pass in and then out of the cells. The structures are constructed of an acoustic metamaterial infill.

### 2. Discussion of the Background

A common environment found in aerospace, military, industrial and commercial applications is that of high frequency, high amplitude acoustic noise. Such high noise environments can prove hazardous to equipment and personnel.

### SUMMARY OF THE INVENTION

An acoustic metamaterial acoustic infill structure for diminishing acoustic noise has a first stage having a first-stage top surface and a first-stage bottom surface. A first-stage nozzle extends through the first-main-stage top surface and through the first-stage bottom surface so as to allow sound waves to pass there through. The first stage-nozzle has a first-stage-nozzle axial centerline. The first-stage nozzle has a first-stage nozzle inner surface and a first-stage nozzle outer surface.

A first-stage sidewall has a first-stage-sidewall outer surface and a first-stage-sidewall inner surface. A first-stage chamber has a first-stage-chamber ceiling and a first-stage-chamber floor, with the first-stage chamber being defined by said first-stage-sidewall inner surface, the first-stage nozzle outer surface, the first-stage-chamber ceiling, and by the first-stage-chamber floor.

The first-stage outer sidewall makes a perpendicular connection to the first-stage-chamber ceiling and to the first-stage chamber floor; with the first stage having a first-stage bottom-floor passage extending from the first-stage-chamber floor through the first-stage bottom surface.

An intermediate stage has an intermediate-stage top surface and an intermediate-stage bottom surface. An intermediate-stage nozzle extends through the intermediate-stage top surface and through the intermediate-stage bottom surface allowing sound waves to pass there through. The intermediate-stage-nozzle has an intermediate-stage axial centerline, with the intermediate-stage nozzle having an intermediate-stage-nozzle inner surface and an intermediate-stage-nozzle outer surface. The intermediate stage includes an intermediate-stage sidewall having an intermediate-stage-sidewall outer surface and an intermediate-stage-sidewall inner surface.

The intermediate-stage chamber has an intermediate-stage-chamber ceiling and an intermediate-stage-chamber floor; with the intermediate-stage chamber being defined by the intermediate-stage-sidewall inner surface, the intermediate-stage nozzle outer surface, the intermediate-stage chamber ceiling, and by the intermediate-stage-chamber floor. The intermediate-stage outer sidewall makes a perpendicular connection to the intermediate-stage-chamber ceiling and to the intermediate-stage chamber floor. An intermediate-stage top surface passage directly connects with the first-stage bottom-floor passage for direct acoustic connection between the first-stage chamber and the intermediate stage chamber. The intermediate stage has an intermediate-stage bottom-floor passage extending from said intermediate-stage-chamber floor through said intermediate-stage bottom surface.

A final stage has a final-stage top surface and a final-stage bottom surface. The final-stage nozzle extends through said final-stage top surface and through the final-stage bottom surface allowing sound waves to pass there through. The final-stage-nozzle has a final-stage axial centerline, with the final-stage nozzle having a final-stage-nozzle inner surface and a final-stage-nozzle outer surface. A final-stage sidewall has a final-stage-sidewall outer surface and a final-stage-sidewall inner surface.

A final-stage chamber has a final-stage-chamber ceiling and a final-stage-chamber floor, with the final-stage chamber being defined by the final-stage-sidewall inner surface, the final-stage nozzle outer surface, the final-stage chamber ceiling, and by the final-stage-chamber floor. The final-stage outer sidewall makes a perpendicular connection to the final-stage-chamber ceiling and to the final-stage chamber floor, with the intermediate-stage bottom-floor passage acoustically connecting with said final-stage chamber.

The final-stage top surface can be stacked upon the intermediate-stage bottom surface, with the first-stage bottom surface stacked upon the intermediate stage top surface so as to form a cell.

Sidewall holes or passages are provide in the respective sidewalls of the respective stages so that adjacent cells can be acoustically connected to form an amalgamation of cells for purposes of acoustically protecting items, components or personnel from deleteriously high sound levels.

The nozzles are formed so that they are securely connected to the nozzles of the succeeding stage. The design of the nozzle of the present invention are elected for easily reproducible, economical shapes with an additive manufacturing perspective. Such shapes include cylindrical or conically-shaped nozzles, or even nozzles having a square or rectangular shape when viewed from a top cross-sectional view, with the nozzles easily interconnecting to nozzles of succeeding stages. The chamber or chambers of the respective stages are positioned radially outward from a center-line axis that passes through each respective nozzle of the stacked stages.

### DESCRIPTION OF THE DRAWINGS

A more complete appreciation of the invention and many of the attendant advantages thereof will be readily obtained by reference to the following detailed description when considered in connection with the accompanying drawings.

FIG. 1 is a side, cross-sectional view of an optional initial stage 100 in accordance with the present invention taken along line AA of FIG. 3.

FIG. 2 is a perspective cross-sectional view of the optional initial stage 100.

FIG. 3 is a top perspective view of the optional initial stage 100.

FIG. 4 is a bottom perspective view of the optional initial stage 100.

FIG. 5 is a side, cross-sectional view of first main stage 200, in accordance with the present invention, taken along line BB of FIG. 7.

FIG. 6 is a perspective cross-sectional view of first main stage 200.

FIG. 7 is a top perspective view of the first main stage 200.

FIG. 8 is a bottom perspective view of the first main stage 200.

FIG. 9 is a cross-sectional view of cell 10, in accordance with the present invention, taken along line CC of FIG. 11, with cell 10 consisting of optional initial stage 100, first main stage 200, intermediate main stage 300, and final main stage 400.

FIG. 10 is a perspective, cross-sectional view of cell 10 in accordance with the present invention;

FIG. 11 is a top, perspective view of cell 10.

FIG. 12 is a bottom, perspective view of cell 10.

FIG. 13 is a top, perspective view of an amalgamation of cells 50 in accordance with the present invention.

FIG. 14 is a bottom, perspective view of the amalgamation of cells 50 of FIG. 13.

FIG. 15 is a perspective view of a sphere 1000 in accordance with the present invention consisting of cells, with the FIG. 15 including an x-ray view of an inner chamber Q in which components 500 are located.

FIG. 16 is a graphical illustration depicting the sound level L that surrounds sphere 1000 and the sound level in inner chamber Q.

FIG. 17 is a side-cross sectional view of a cell 10′ in an alternative embodiment of the present invention.

FIG. 18 is a perspective-cross sectional view of cell 10′ of FIG. 17.

### DETAILED DESCRIPTION

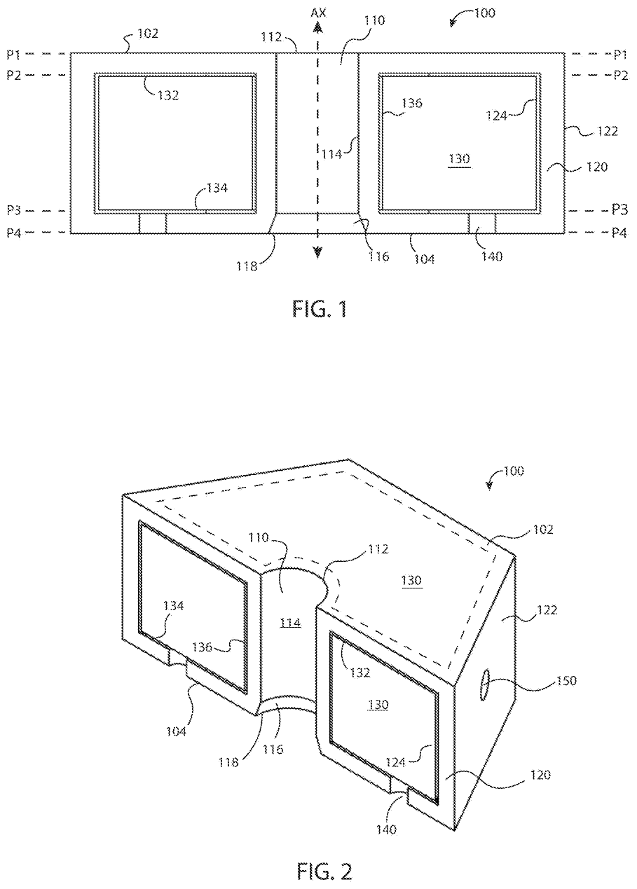

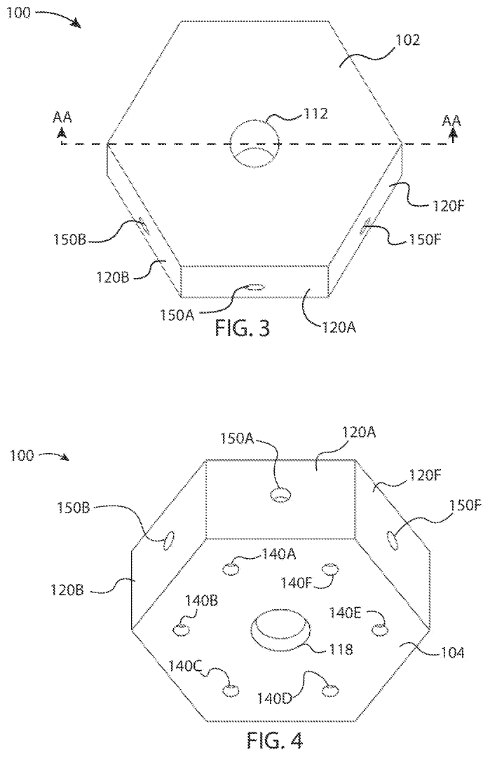

With reference to FIGS. 1 and 2, an initial stage 100 has a top surface 102 and a bottom surface 104. Initial stage 100 has a nozzle 110 having a top opening 112. A center axis line AX represents an axial line extending through the center of nozzle 110 such that an inner surface 114 of nozzle 110 is positioned radially outward from the center axis line AX. Nozzle 110 has a tapered bottom section 116 such that the bottom opening 118 of nozzle 110 has a greater radial distance from center axis line AX than the radial distance from center axis line AX to inner surface 114.

Initial stage 100 has a sidewall 120 having an exterior surface 122 and an inner surface 124. Inner surface 124 of sidewall 120 combined with chamber ceiling 132, chamber floor 134 and chamber interior wall 136 from chamber 130. (The chamber interior wall 136 can be understood as being an exterior wall or surface of the nozzle). The chamber 130 has a passage or hole 140 extending through the chamber floor 134 and through the bottom surface 104 of the initial stage 100. In addition, initial stage 100 is provided with a lateral passage or hole 150 that extends through exterior surface 122 and through the inner surface 124 of sidewall 120.

The top surface 102 of initial stage 100 is contained within plane P1 and the ceiling 132 of chamber 130 is contained within plane P2, with planes P1 and P2 being in parallel with one another. The floor 134 of chamber 130 is contained within plane P3 and the bottom surface 104 of initial stage 100 is contained within plane P4, with planes P1, P2, P3 and P4 being in parallel, and center axial line AX of nozzle 110 being normal to planes P1, P2, P3 and P4.

In FIG. 3 and FIG. 4, the top and bottom perspective views demonstrates that initial stage 100 has a plurality of sidewalls, such as sidewalls 120A, 120B, 120C, 120D, 120E and 120F that surround nozzle 110 and connect to top surface 102 and bottom surface 104.

Chamber bottom passages 140A, 140B, 140C, 140D, 140E and 140F extend through the chamber floor 134 and through the bottom surface 104 so as to allow sound waves to exit chamber 130. In addition, each respective sidewall, e.g., sidewalls 120A, 120B, 120F, are provided with respective lateral passages or holes 150A, 150B, 150F that allow sound waves to exit chamber 130.

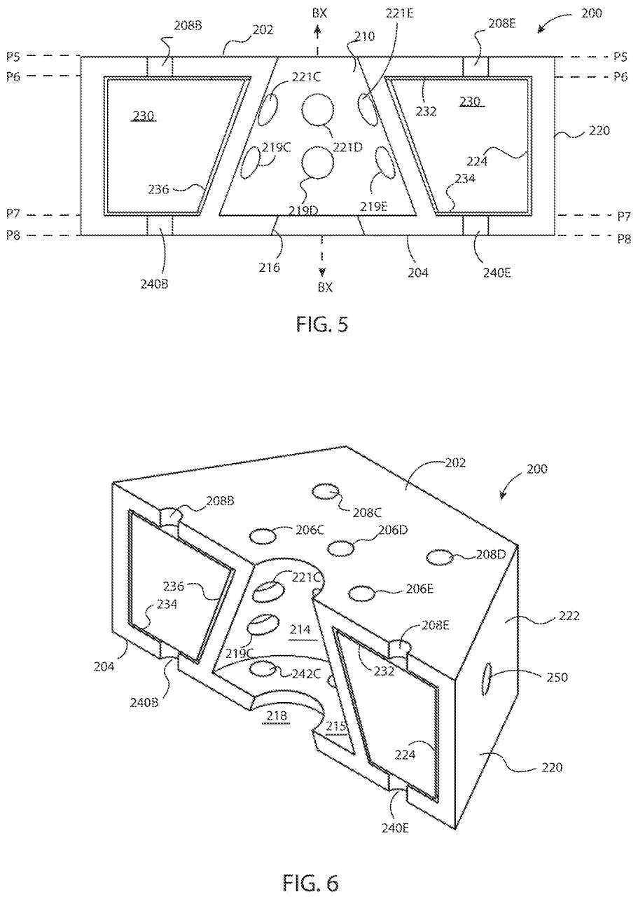

With reference to FIGS. 5 and 6, a first main stage 200 has a top surface 202 and a bottom surface 204. First main stage 200 has a nozzle 210 having a top opening 212. Top opening 212 is circular and of a given radius. Nozzle 210 is conical in shape, with a center axis line BX representing an axial line extending through the center of nozzle 210 such that an inner surface 214 of nozzle 210 is positioned radially outward from the center axis line BX. Nozzle 210 has a peripheral nozzle floor 215. A tapered bottom section 216 connects the nozzle floor 215 with the bottom surface 204 of the first main stage and forms an axial exit path 218.

The tapered bottom section 216 allows for a secure connection with a nozzle of a subsequent stage. Peripheral nozzle floor 215 is provided with nozzle floor holes (e.g., nozzle floor holes or passages 217B, 217C, 217E) which extend through the peripheral nozzle floor 215 and through the bottom surface 204 of the first main stage 200 so as to allow acoustical connection to a subsequent stage. Upper radial holes (e.g., holes 221C, 221D, 221E) are radially located at the upper region of the nozzle 210 and extend through the nozzle inner surface 214 and through from chamber interior wall 236 so as to acoustically connect the nozzle 210 with chamber 230.

Lower radial holes (e.g., holes 219C, 219D, 219E) are radially located at the lower region of the nozzle 210 and extend through the nozzle inner surface 214 and through from chamber interior wall 236 so as to make additional acoustic connections with nozzle 210 and chamber 230.

First main stage 200 has a sidewall 220 having an exterior surface 222 and an inner surface 224. Inner surface 224 of sidewall 220 combined with chamber ceiling 232, chamber floor 234 and chamber interior wall 236 form chamber 230. (The chamber interior wall 236 can be understood as being an exterior wall or surface of the nozzle 210.) The chamber 230 has a passage or hole 240 extending through the chamber floor 234 and through the bottom surface 204 of the first main stage 200. In addition, first main stage 200 is provided with a lateral passage or hole 250 that extends through exterior surface 222 and through the inner surface 224 of sidewall 220.

The top surface 202 of first main stage 200 is contained within plane P5 and the ceiling 232 of chamber 230 is contained within plane P6, with planes P5 and P6 being in parallel with one another. The floor 234 of chamber 230 is contained within plane P7 and the bottom surface 204 of first main stage 200 is contained within plane P8, with planes P5, P6, P7 and P8 being in parallel, and center axial line BX of nozzle 210 being normal to planes P5, P6, P7 and P8.

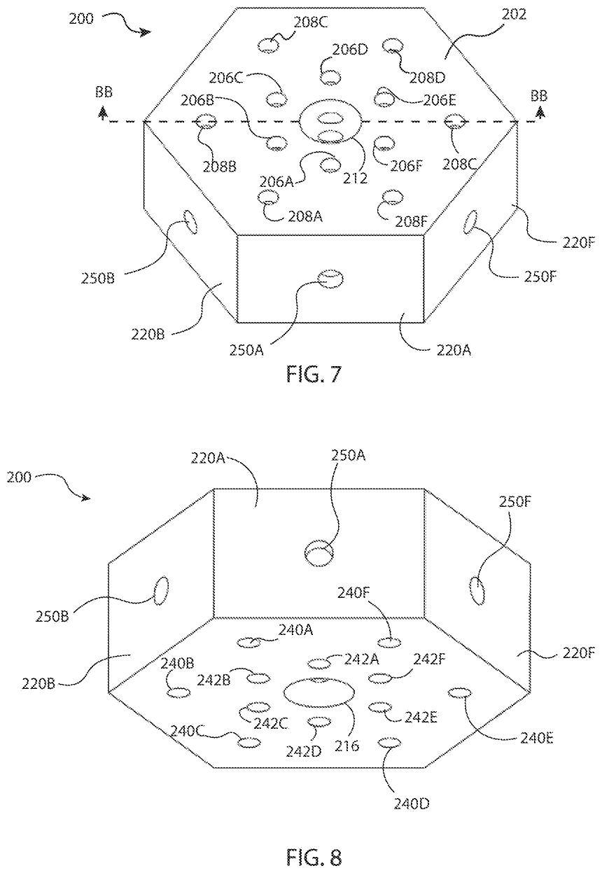

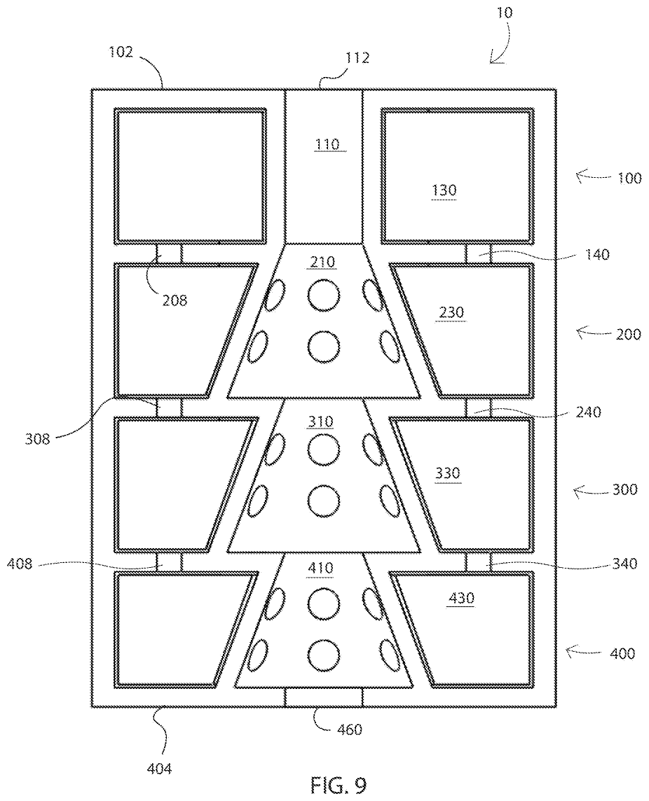

In FIG. 7 and FIG. 8, the top and bottom perspective views demonstrates that first main stage 200 has a plurality of sidewalls, such as sidewalls 220A, 220B, 220C, 220D, 220E and 220F that surround nozzle 210 and connect to top surface 202 and bottom surface 204. Chamber bottom passages 240A, 240B, 240C, 240D, 240E and 240F extend through the chamber floor 234 and through the bottom surface 204 so as to allow sound waves to exit chamber 230.

Top surface outer passages 208A, 208B, 208C, 208D, 208E, and 208F (FIG. 7) extend through the top surface 202 of first main stage 200 so as to provide acoustical passages into chamber 230. Top surface inner passages 206A, 206B, 206C, 206D, 206E, and 206F (FIG. 7), located radially inward from top surface outer passages 208A, 208B, 208C, 208D, 208E, and 208F, extend through the top surface 202 of first main stage 200 so as to provide additional acoustical passages into chamber 230. In addition, each respective sidewall, e.g., sidewalls 220A, 220B, 220F, are provided with respective lateral passages or holes 250A, 250B, 250F that allow sound waves to exit chamber 230.

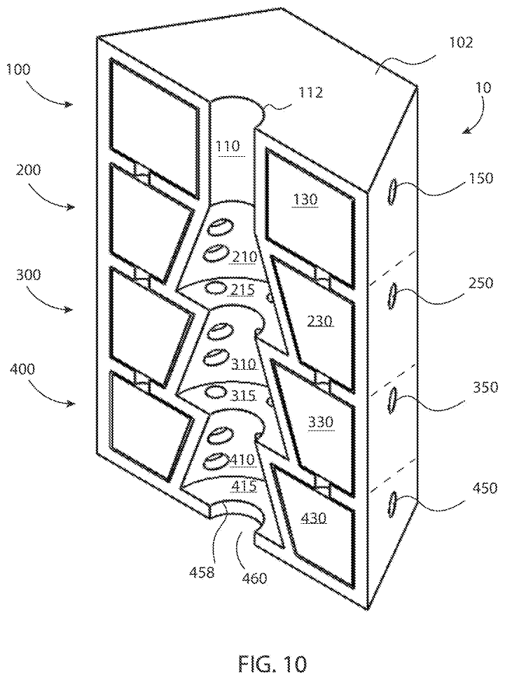

With reference to FIGS. 9 and 10, initial stage 100 is stacked upon first main stage 200, with first main stage 200 being stacked upon intermediate main stage 300. First main stage 200 and intermediate main stage 300 are identical in shape and construction. A final stage 400 is similar in shape and construction to main stage 200 and intermediate main stage 300; however, the final stage 400 has only a single exit hole 460 which allows sound waves to exist nozzle 410. The stacked configuration of initial stage 100, first main stage 200, intermediate main stage 300, and final stage 400 forms a cell 10. Passages in the bottom surface 204 of first main stage 200 connect to respective passages in the top surface of intermediate main stage 300 and passages in the bottom surface of intermediate main stage 300 connect with respective passages in the top surface of final stage 400.

Chamber 430 is provided with lateral passages, such as lateral passage 450F, to allow lateral transmission of sound waves from the chamber through the respective sidewalls, e.g., sidewall 420F. Final stage 400 has no passages in its bottom surface 404 that lead directly from chamber 430 to the outside of stage 400.

The inner edge 458 of bottom peripheral floor 415 of final stage 400 provides the shape of exit hole 460. No other holes exist in the peripheral floor 415. Exit hole 460 allows air circulation to extend from the opening 112 at the top of nozzle 110 of the first stage 100 through the successive stages 200, 300 and 400 and through exit hole 416.

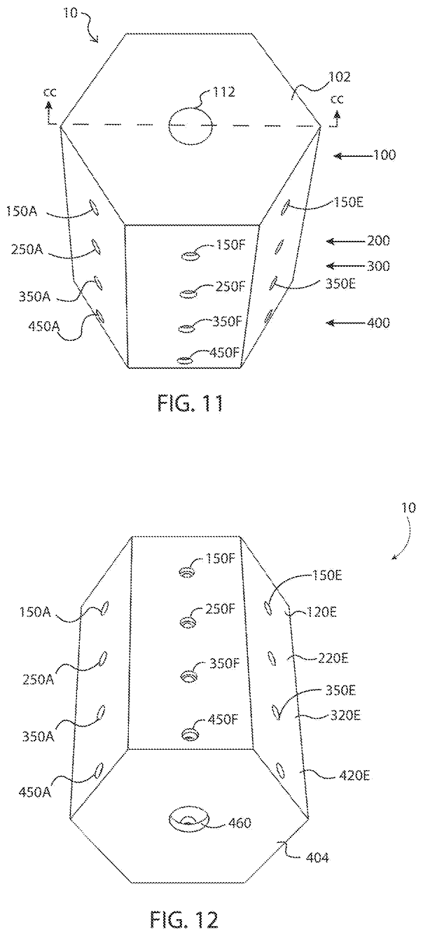

In FIGS. 11 and 12, cell 10 has initial stage 100, first main stage 200, intermediate main stage 300 and final stage 400 stacked upon one another. Lateral passages, e.g. passages 150A, 250A, 350A, 450A, 150E, 250E, 350E, 450E, 150F, 250F, 350F, 450F, allow the respective chambers 130, 230, 330, 430 to acoustically communicate with the chambers of adjacent cells.

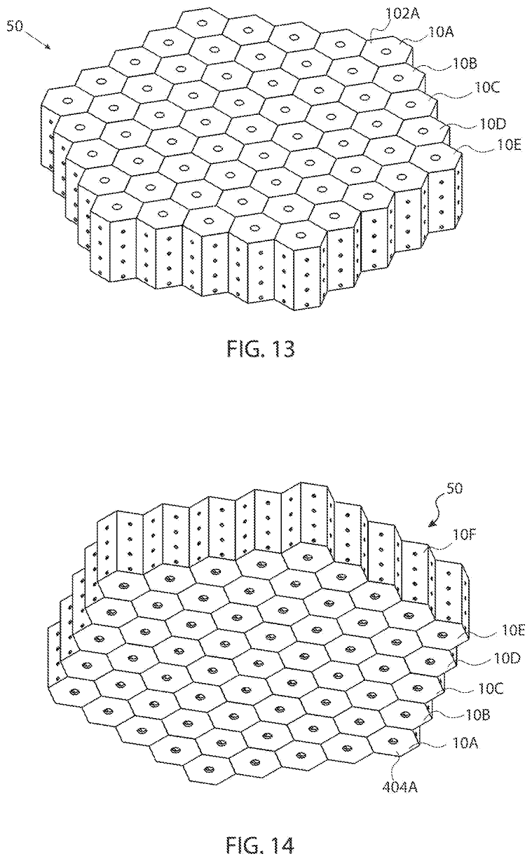

In FIGS. 13 and 14, an amalgamation of cells 50 includes cells 10A, 10B, 10C, 10D, 10E that connect together.

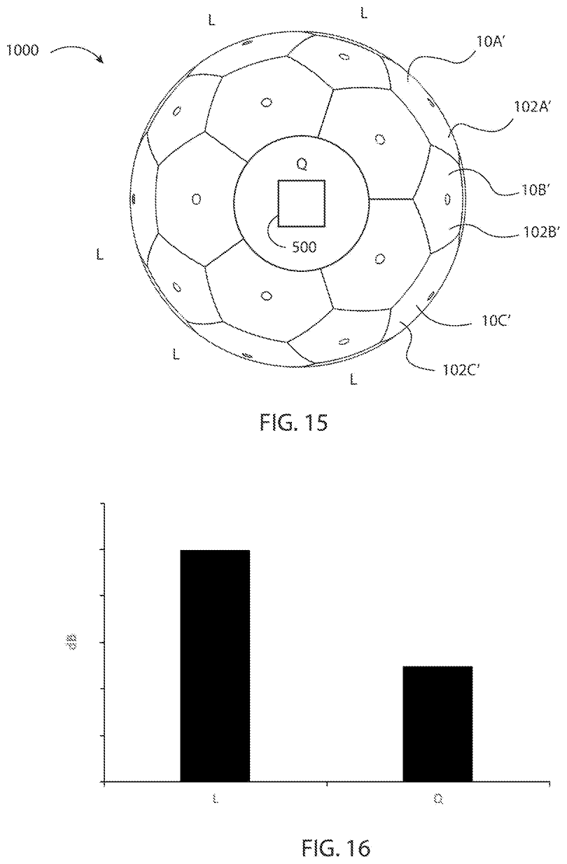

In FIG. 15, a sphere 1000 is located within an atmosphere that is surrounded by sound waves L. The sphere is constructed from cells 10A′, 10B′, 10C′ which connect to other cells to construct the sphere 1000. The cells form an interior chamber Q in which is located components 500. As a result of the cells of the sphere surrounding the chamber Q, the components 500 experience a much reduced sound level than sound level L that is present outside of the sphere.

In FIG. 16 the graphical representation demonstrates that the decibel level L of sound outside of sphere 1000 of FIG. 15 is much greater than the sound experienced in chamber Q inside of the sphere 1000.

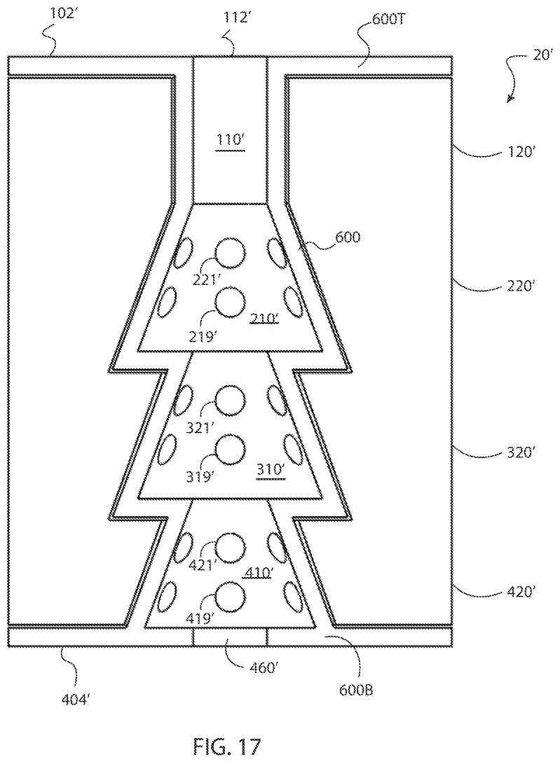

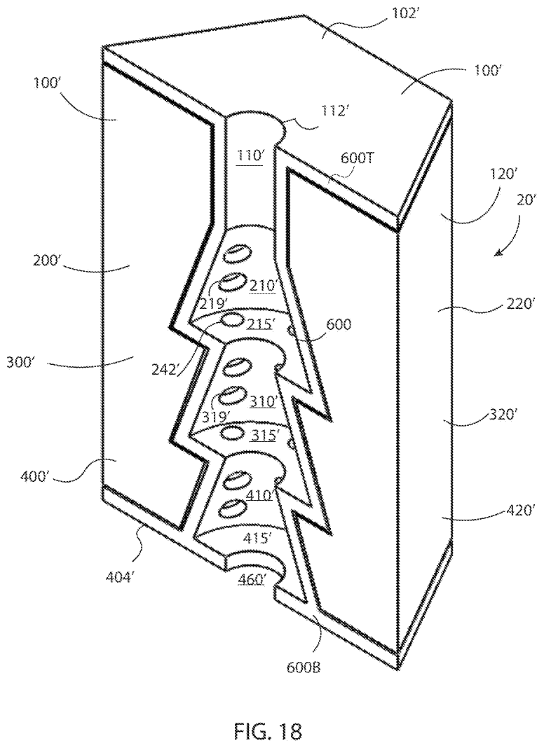

In FIGS. 17 and 18, an alternative embodiment of the present invention is demonstrated in which is the respective chambers 130, 230, 330, 430 in FIGS. 1 though 10 have been replaced by a hollow acoustic path 600 that surrounds nozzles 110′, 210′, 310′ and 410′ of respective stages 100′, 200′, 300′ and 400′ which form cell 20′.

The acoustic path 600 has a top portion 600T located just below the top surface 102′ that extends radially outward from a top portion of nozzle 110′. A bottom portion 600B of the acoustic path 600 extends radially outward at a bottom region of nozzle 410′ just above bottom surface 404′ of final stage 400′. The respective sidewalls of stage 100′ close off top portion 600T and the respective sidewalls of final stage 400′ close off bottom portion 600B. Opening 112′ of nozzle 110′ and opening 460′ of nozzle 410′ provide a direct axial path.

Experimentation has demonstrated that the present invention reduces acoustic noise in both directions, i.e., whether the noise originates from the top or bottom of a cell. In addition, in that the different cells can be formed into various geometric shapes, the invention can provide acoustical protection in all directions.

The geometric shapes of the nozzles and passages as described above allow for economical reproduction of the cell structure through additive manufacturing techniques. Additive manufacturing techniques include but are not limited to three-dimensional printing, jetting, and lamination. Infill patterns include but are not limited to porous hexagonal, gyroid, grid, and cubic.

Various modifications and embodiments of the invention may be made by those skilled in the art without departing from the scope and spirit of the foregoing disclosure. Accordingly, the scope of the invention is limited only by the following claims.

What is claimed is:

1. An acoustic metamaterial infill structure for diminishing acoustic noise, comprising:
a first stage having a first-stage top surface and a first-stage bottom surface;
a first-stage nozzle extending through said first-main-stage top surface and through said first-stage bottom surface allowing sound waves to pass there through, said first stage-nozzle having a first-stage-nozzle axial centerline, said first-stage nozzle having a first-stage nozzle inner surface and a first-stage nozzle outer surface;
a first-stage sidewall having a first-stage-sidewall outer surface and a first-stage-sidewall inner surface;
a first-stage chamber having a first-stage-chamber ceiling and a first-stage-chamber floor; said first-stage chamber being defined by said first-stage-sidewall inner surface, said first-stage nozzle outer surface, said first-stage-chamber ceiling, and by said first-stage-chamber floor; and wherein:
said first-stage outer sidewall making a perpendicular connection to said first-stage-chamber ceiling and to said first-stage chamber floor; and said first stage having a first-stage bottom-floor passage extending from said first-stage-chamber floor through said first-stage bottom surface.

2. An acoustic metamaterial acoustic infill structure for diminishing acoustic noise, according to claim 2, further comprising:
an intermediate stage having an intermediate-stage top surface and an intermediate-stage bottom surface;
an intermediate-stage nozzle extending through said intermediate-stage top surface and through said intermediate-stage bottom surface allowing sound waves to pass there through, said intermediate-stage-nozzle having an intermediate-stage axial centerline, said intermediate-stage nozzle having an intermediate-stage-nozzle inner surface and an intermediate-stage-nozzle outer surface;
an intermediate-stage sidewall having an intermediate-stage-sidewall outer surface and an intermediate-stage-sidewall inner surface;
an intermediate-stage chamber having an intermediate-stage-chamber ceiling and an intermediate-stage-chamber floor; said intermediate stage chamber being defined by said intermediate-stage-sidewall inner surface, said intermediate-stage nozzle outer surface, said intermediate-stage chamber ceiling, and by said intermediate-stage-chamber floor; and wherein:
said intermediate-stage outer sidewall making a perpendicular connection to said intermediate-stage-chamber ceiling and to said intermediate-stage chamber floor; and
said first-stage bottom surface being stacked upon said intermediate-stage top surface, with said first-stage axial center line being aligned with said intermediate-stage axial center line.

3. An acoustic metamaterial acoustic infill structure for diminishing acoustic noise, according to claim 2, wherein:
said intermediate stage having an intermediate-stage bottom-floor passage extending from said intermediate-stage-chamber floor through said intermediate-stage bottom surface.

4. An acoustic metamaterial acoustic infill structure for diminishing acoustic noise, according to claim 3, further comprising:
a final stage having a final-stage top surface and a final-stage bottom surface;
a final-stage nozzle extending through said final-stage top surface and through said final-stage bottom surface allowing sound waves to pass there through, said final-stage-nozzle having a final-stage axial centerline, said final-stage nozzle having a final-stage-nozzle inner surface and a final-stage-nozzle outer surface;
a final-stage sidewall having a final-stage-sidewall outer surface and a final-stage-sidewall inner surface;
a final-stage chamber having a final-stage-chamber ceiling and a final-stage-chamber floor; said final-stage chamber being defined by said final-stage-sidewall inner surface, said final-stage nozzle outer surface, said final-stage chamber ceiling, and by said final-stage-chamber floor; and wherein:
said final-stage outer sidewall making a perpendicular connection to said final-stage-chamber ceiling and to said final-stage chamber floor;
said intermediate-stage bottom-floor passage acoustically connecting with said final-stage chamber; and
said final-stage top surface being stacked upon said intermediate-stage bottom surface, with said first-stage axial center line being aligned with said intermediate-stage axial center line and said final-stage axial center line.

5. An acoustic metamaterial acoustic infill structure for diminishing acoustic noise, according to claim four, wherein:
said first-stage nozzle has a cylindrical shape and said intermediate-stage nozzle is conical in shape, with the top of said intermediate stage nozzle fitting into a tapered opening of said first stage nozzle.

6. A acoustic metamaterial acoustic infill structure for diminishing acoustic noise, according to claim 5, wherein:
said intermediate-stage nozzle has an intermediate-stage-nozzle peripheral floor that surrounds the tapered opening of said intermediate-stage nozzle, with said intermediate stage peripheral floor having an intermediate-stage peripheral floor passage that acoustically connects said intermediate stage nozzle to said final-stage chamber.
